(19) United States
(12) Patent Application Publication
(10) Pub. No.: US 2008/0059020 A1
(43) Pub. Date: Mar. 6, 2008

(54) Data Recorder For Vehicle

(75) Inventor: Jin SATO, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/836,569

(22) Filed: Aug. 9, 2007

(30) Foreign Application Priority Data
Aug. 31, 2006 (JP) 2006-234859

(51) Int. Cl. G06F 19/00

(52) U.S. Cl. 701/35

(57) ABSTRACT

A data recorder for vehicle compares a difference between previously acquired data and presently acquired data with a data threshold value which is set to every abnormal occurrence for a time-series data recorded temporarily in RAM, and determines whether the data is recorded in a data recording device, when various types of data associated with the abnormal occurrence is recorded. Specifically, if it is necessary to record the data with a fine accuracy, a setting of the threshold value for the data is made small, and if it is necessary to record the data with a coarse accuracy, a setting thereof for the data is made large. Accordingly, the data recording accuracy is appropriately set in correspond with the abnormal occurrence, therefore, the cause of the abnormal occurrence is ascertained later without using a recording capacity wastefully.

### BACKGROUND OF THE INVENTION

The present invention relates to a data recorder for vehicle.

In the past, a data recording device has been known that it records data associated with abnormal occurrences in order to analyze the cause of the occurrences later when operational abnormalities arise from devices.

In the meantime, in the case of analyzing the cause of abnormal occurrences later, enormous quantity of data must be recorded. However, a capacity of data recording area is restricted, therefore, it is desirable that the restricted capacity should be effectively used without recording unnecessary data.

From such viewpoint, a device disclosed in JP-A-2004-36506 has been known how data associated with the abnormal occurrences is sorted out and recorded in a recording device by which of the quantity of data is appropriate. Specifically, priority is given to the data associated with the abnormal occurrence having a high occurrence frequency to then record the data in the recording device. The data associated with the abnormal occurrence having the high occurrence frequency is also recorded as the same quantity as that of data or near to that quantity.

Incidentally, it is necessary to record preferably various types and large pieces of data and long time-series data associated with the abnormal occurrence. On the contrary, it is not desirable to record large pieces of data wastefully because a capacity of data recording area is restricted.

### SUMMARY OF THE INVENTION

The present invention is to solve a problem of the above-mentioned technique. An object of the present invention is to provide a data recorder, a data recording method and a computer readable program to be able to effectively use a restricted recording capacity of a data recording unit, and effectively record data used for ascertaining the cause of abnormalities or failures in devices.

According to one aspect of the invention, a data recorder includes: a data acquiring unit that acquires data for use in a vehicle; a comparison unit that compares previously acquired data with presently acquired data; a judgment unit that judges whether the presently acquired data is recorded in response to a comparison result from the comparison unit; a dataset management unit that creates a present dataset including the presently acquired data and a recording flag for the presently acquired data when the judgment unit judges that the presently acquired data is recorded, and does not create a present dataset including at least the presently acquired data when the judgment unit judges that the presently acquired data is not recorded; and a recording unit that records the present dataset created by the data set management unit in a recording device.

According to the invention, the restricted recording capacity is used effectively in the data recording device, so that data can be recorded effectively to use for ascertaining the cause of abnormalities or failure in various devices.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram of a data recorder for vehicle in an embodiment of the invention.

FIG. 2 is a flow chart of a data recording program for data associated with an abnormal occurrence in the data recorder for vehicle in the embodiment of the invention.

FIG. 3 is a flow chart showing the process of step S200 in FIG. 2.

FIGS. 4A, 4B and 4C are schematic diagrams showing how data is recorded in a RAM 23 and a data recording device 26 by the process of step S200 in FIG. 2.

FIG. 5 is a schematic diagram showing the relationship between a recording flag and recording data in the embodiment of the invention.

FIG. 6 is a schematic diagram showing how the recording flags and recording data are recorded in the data recording device 26 by the process of step S300 in FIG. 2.

FIG. 7 is a schematic diagram showing a specific example of values to be set by the steps S140 to S160 in FIG. 2.

FIG. 8 is a schematic diagram showing a specific example of data recorded temporarily in the RAM 23 in FIG. 1.

FIG. 9 is a schematic diagram showing a result example of editing data shown in FIG. 8 on the basis of the setting in FIG. 7 by the process of step S200 in FIG. 2.

FIG. 10 is a schematic diagram showing a result example of editing data shown in FIG. 8 on the basis of the setting in FIG. 7 by the process of step S200 in FIG. 2.

FIG. 11 is a schematic diagram showing a result example of editing data shown in FIG. 8 on the basis of the setting in FIG. 7 by the process of step S200 in FIG. 2.

### DESCRIPTION OF THE EMBODIMENTS

Hereinafter, embodiments of a data recorder in the invention will be described with reference to the drawings. Specifically, a data recorder, a data recording method and a computer readable program will be described, as examples, so that various types of data relative to a control device can be collected and recorded surely in a data recording device in which a limited recording capacity is effectively used, when abnormal occurrences arise in an electronic control device or a control unit etc. mounted on a vehicle.

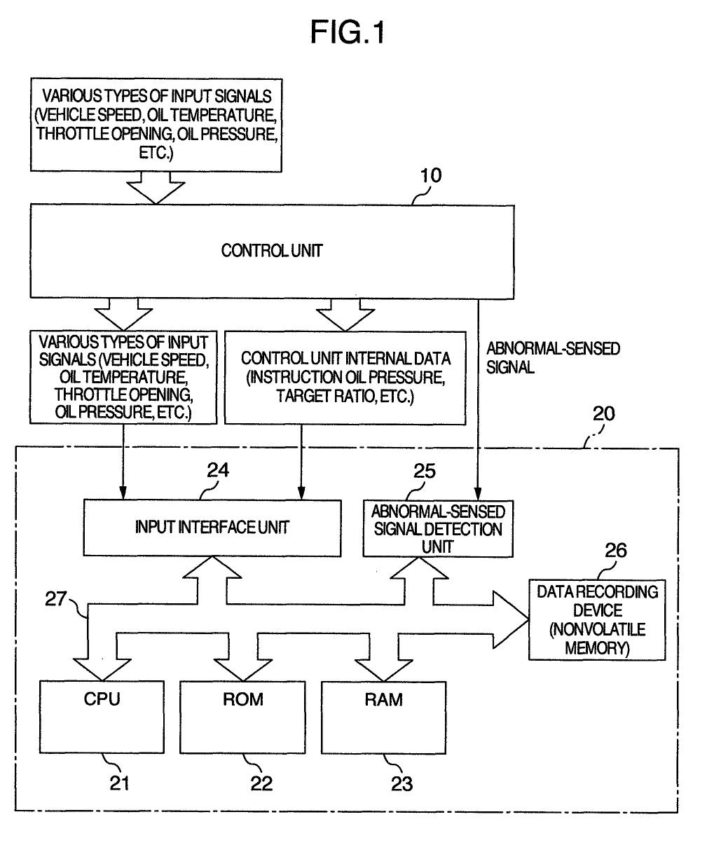

FIG. 1 is a schematic block diagram showing a data recorder for vehicle in the embodiment.

A data recorder 20 for vehicle is connected to a control unit 10 for controlling equipment such as an engine, an automatic transmission, etc. The control unit 10 receives input signals, for example, a vehicle speed signal, an oil temperature signal, a throttle opening signal, an oil pressure signal, etc. from various types of sensors in order to control the equipment including the engine, the automatic transmission, etc. The control for the equipment is therefore carried out on the basis of these input signals. The data recorder 20 includes: a CPU 21 for dealing with an entire control for the data recorder; a ROM 22 stored various types of programs; a RAM 23 for recording temporarily various types of data; a data recording device 26 (for example, a nonvolatile memory such as EEPROM, Flash ROM, etc.) for recording data associated with abnormal occurrences as data recording means; an input interface unit 24 for receiving the various types of signals output from the control unit 10; and an abnormal-sensed signal detection unit 25 for detecting an abnormal detected signal output from the control unit 10. The above-mentioned these elements are connected with a bus 27 so that the signals can be transmitted and received one another.

The abnormal detected signals output from the control unit 10 are signals detected in response to every abnormal occurrence, which is given by “0001” in the case where a vehicle speed sensor is abnormal, “0002” in the case where an oil pressure sensor is abnormal, etc. The ROM 22 stores data for acquiring analysis of the abnormal occurrences, and threshold values to be set to every data corresponding to each of the abnormal occurrences (referring to FIG. 7, for example). The data setting may be determined to record data of a time period at which it starts and ends from a before-abnormal detection to an after-abnormal detection for each of the abnormal occurrences. For example, in the case of an abnormal occurrence to acquire data at the before-abnormal detection, the data setting may be determined to record the data from the before-abnormal detection to at-a-time of the abnormal detection. In the case of an abnormal occurrence to acquire data at the after-abnormal detection, the data setting may be determined to record the data from the after-abnormal detection.

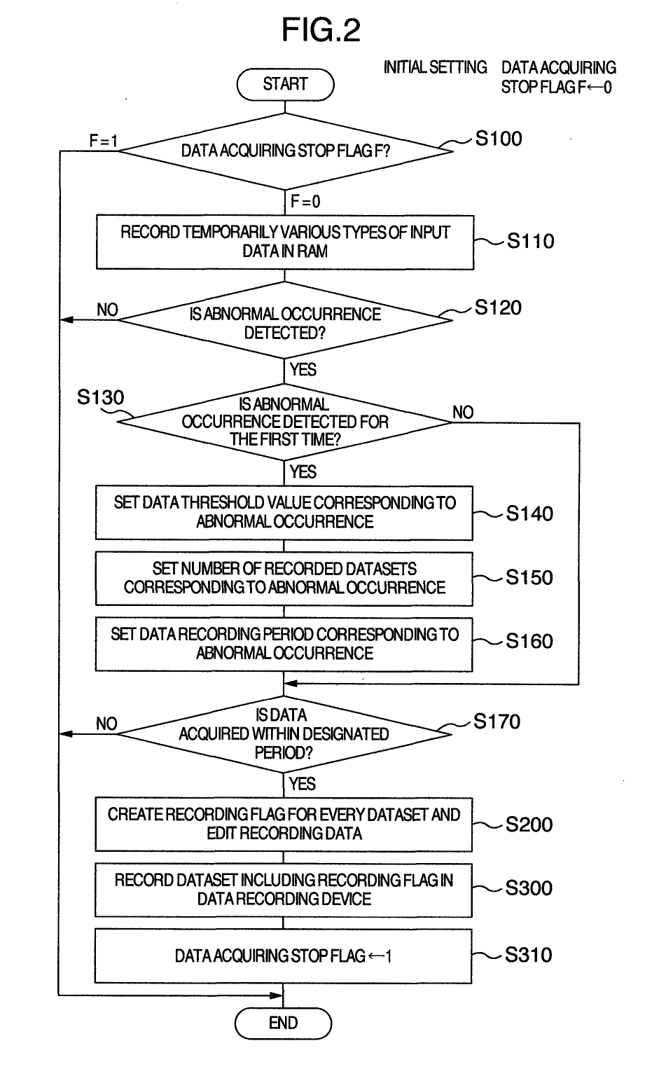

Next, an operation of the data recorder 20 in the embodiment will be described with a flow chart shown in FIG. 2. The CPU 21 in data recorder 20 reads out and executes a vehicle data recording program recorded in the ROM 22 during a predetermined sampling cycle (for example, every 100 msec).

First, the program started in the CPU 21 judges whether the value of a data acquiring stop flag F is “0” or “1” in a step S100. The data acquiring stop flag F is a flag which is reset to “0” at an initial setting, and set to “1” in a step S310 as described later when any abnormal occurrences arise and acquisition of various types of data is completed. When the data acquiring stop flag F is “0” in the step S100, that is, data acquired during a designated period is not recorded in the nonvolatile memory, the process moves to a step S110 to record temporarily, in the RAM 23 through the input interface unit 24, various types of data (for example, a vehicle speed, an oil temperature, a throttle opening, an oil pressure, etc.) entered from the control unit 10 and internal data (a designated oil pressure, a target ratio, etc.) in the control unit 10. Incidentally, the RAM 23 has a predetermined recording capacity. Therefore, the latest data is overwritten to the earliest data in the case of recording data which exceeds the predetermined recording capacity.

In a subsequent step S120, an abnormal detected signal from the control unit 10 is detected by the abnormal-sensed signal detection unit 25. The process then judges whether any abnormal occurrences are arisen. When any abnormal occurrences are not detected in this step, subsequent processes are not executed, but completed.

In the meantime, when any abnormal occurrences are detected in the step S120, the process judges that this is an abnormal occurrence detection, and moves to a step S130 to judge whether the detected abnormal occurrence detection has arisen for the first time. If the abnormal occurrence detection is the first time in the step S130, the process moves to a step S140 to set data threshold values corresponding to the abnormal occurrence, set a recording period of data corresponding to the detected abnormal occurrence in a subsequent step S150, and set the number of recording datasets corresponding to the detected abnormal occurrence in a subsequent step S160.

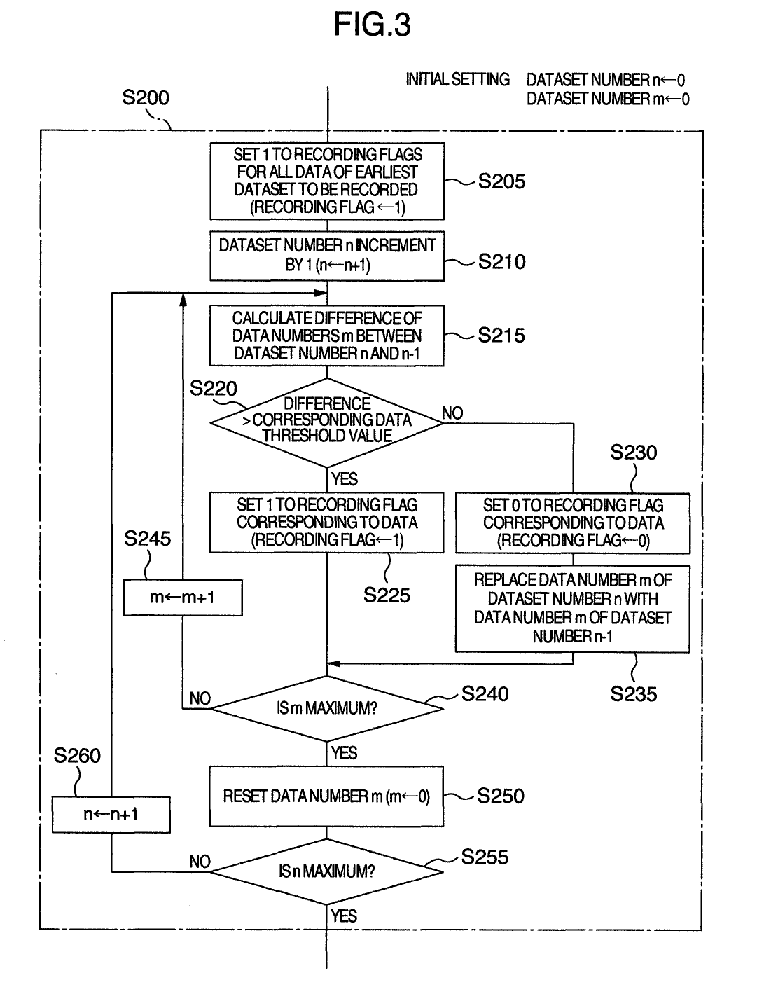

Here, the data threshold value corresponding to the abnormal occurrence which is set by the step S140 means a value which can be set to every abnormal occurrence, and can be set to every data in the dataset. This threshold value is compared with a difference between the previously acquired data value and the presently acquired data value, and this threshold value is used in a step S220 as shown in FIG. 3 which describes processing contents in detail of a step S200 as described later.

Further, the number of datasets corresponding to the abnormal occurrence set in the step S150 means a value for determining whether some time-series datasets are recorded. For example, assuming that the value for the number of datasets to be set by the step S150 is “20”, a setting is made so that a dataset including 20 pieces by a 100 msec sampling cycle can be recorded, that is, datasets during a total 2 sec can be recorded, when the program to be executed at a predetermined timing is executed at every 100 msec.

In addition, a data recording period corresponding to the abnormal occurrence to be set by the step S160 means a value for setting a time period to record data from when the before-abnormal occurrence detection to when the after-abnormal occurrence detection, and for setting the number of datasets at both the before-abnormal occurrence detection and after-abnormal occurrence detection. A sum of these two values becomes equal to the number of recorded datasets set by the step S150. For example, when an execution period of the program is 100 msec and the number of datasets is set to “20” in the step S150, assuming that the data recording period to be set by the step S160 is set to “10” at the before-abnormal occurrence detection and to “10” at the after-abnormal occurrence detection, the setting is made so that both the previously acquired datasets of ten times from the time of detecting the abnormal occurrence and the lately acquired datasets of ten times from the time of detecting the abnormal occurrence can be acquired, that is, the datasets can be acquired in a time period from 1 sec before detecting the abnormal occurrence to 1 second after detecting the abnormal occurrence. The setting value of data recording period can be set to “0”. For example, assuming that the data recording period for the before-abnormal occurrence detection is set to “20” and the after-abnormal occurrence detection is set to “0”, the setting is made so that data can be recorded in a time period from 2 sec before detecting the abnormal occurrence to a time of detecting the abnormal occurrence.

When the detection for the abnormal occurrence is not the first time in the step S130, that is, the abnormal occurrence is already detected and the program has executed to acquire data after arisen the abnormal occurrence, the process skips the steps S140 to S160 and moves to a step S170 since the following items are already set: the data threshold values corresponding to the abnormal occurrence; the number of recorded datasets corresponding to the abnormal occurrence; and the data recording period corresponding to the abnormal occurrence.

In a subsequent step S170, the process judges whether the datasets are recorded within the recording period set by the step S160. For example, in the step S160, when the data recording period is set to “10” at the before-abnormal occurrence detection and “10” at the after-abnormal occurrence detection, the program is executed by 10 times after detecting the abnormal occurrence. The process then judges that data is acquired within the designated period when various types of data are recorded temporarily in the RAM 23 by the step 110.

In a subsequent step S200, a recording flag is created for every dataset and the recorded data is edited. Detailed process of the step S200 will be described with FIG. 3. First, in a step S205, the recording flag for all data in the earliest dataset to be recorded at this time is set to “1” among the temporarily recorded datasets in the RAM 23. Subsequently, a dataset number n is increment by 1 in a step S210. This dataset number n is set to “0” in the initial setting, and is a time-series data number allocated to the data set which is increment in the step S210 and a step S260 as described later, when the editing process is completed for one dataset.

In a subsequent step S215, a difference between the dataset number n recorded temporarily in the RAM 23 in the step S205 and data number m of the dataset number n−1 is calculated. The dataset number n−1 is a dataset acquired at one period earlier than the dataset number n. Here, the data number m is a number allocated to each piece of data to be included in and acquired from the dataset. The data number m is set to “0” in the initial setting, and increment by a step S245 as described later, when the editing process for one piece of data is completed.

In a subsequent step S220, the difference of the data numbers m calculated by the step S215 is compared with the threshold values for each of the dataset by the step S140. If the difference of data number m is larger than the threshold value, the process moves to a step S225 to set “1” to the recording flag of the data number m. On the other hand, if the difference of the data number m is equal to or smaller than the threshold value in the step S220, the process moves to a step S230 to set “0” to the recording flag of the data number m. In a step S235, the value of data number m of the dataset number n−1 is then replaced with data of the data number m in the dataset number n. That is, the data in the dataset is replaced with the data before one cycle of the dataset. In a subsequent step S240, the process judges whether the value of data number m is the maximum value. If it is not maximum, the data number is increment by “1” in a step S245. Thereafter, the process of the step S215 is executed again. On the contrary, if the data number m is the maximum value in the step S240, the process moves to a step S250 to reset the data number m.

In a subsequent step S255, the process judges whether the dataset number n is the maximum value. If it is not maximum, the dataset number n is increment by “1” in a step S260. Thereafter, the process of the step S215 is executed again. On the contrary, if the dataset number n is the maximum value in the step S255, the process in the step S200 is completed, and then moved to the step S300 in FIG. 2. In the process by the step S200 as described above, the recording flags and recording data for each of the datasets are recorded temporarily in the RAM 23.

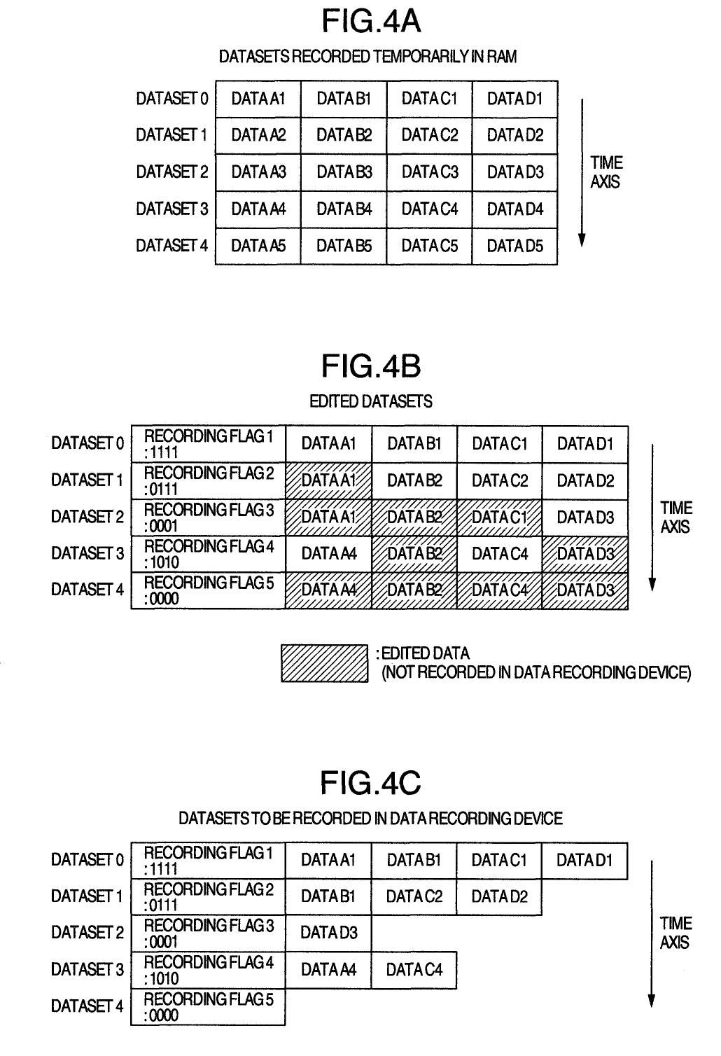

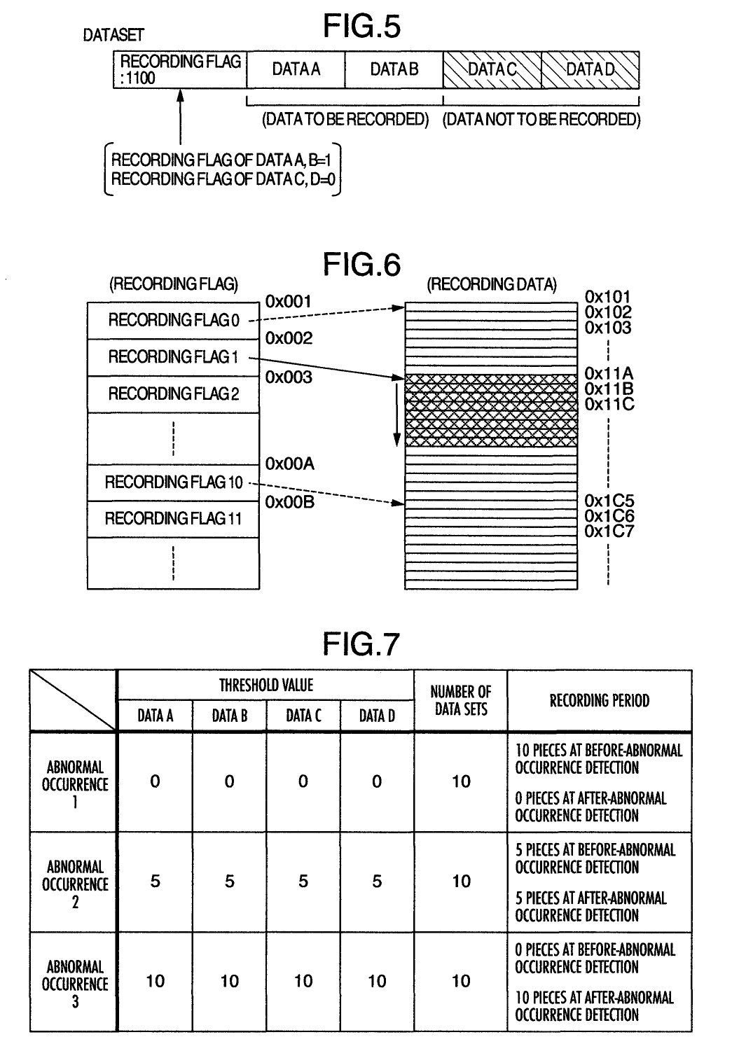

In a subsequent step S300, the recording flags and recorded data for every dataset which are edited and recorded temporarily in the RAM 23 by the step S200 are recorded in the data recording device 26. The data to be recorded in the data recording device 26 by the step S300 has the recording flags and data itself which is judged that the recording flag indicates “1”. FIGS. 4A, 4B and 4C show outlines of the datasets recorded temporarily in the RAM 23, the edited datasets after edited by the step S200, and the datasets to be recorded in the data recording device 26. Further, FIG. 5 shows a relationship between the value of recording flag and the recording data. In this way, the data set with “1” as the recording flag is only recorded, so that quantity of data to be recorded can be reduced entirely.

In a subsequent step S310, “1” is set to the data acquiring stop flag F representing that all datasets have been recorded for necessity of any abnormal occurrences, and the program relative to the process is completed. After “1” is set to the data acquiring stop flag F, the process becomes completed because the data acquiring stop flag F indicates “1” in the step S100, even though the program is executed by a predetermined timing. After the all necessary datasets are recorded in response to the abnormal occurrences, the values for datasets are not updated any more.

Next, a data recording method will be described with FIGS. 5 and 6. This method corresponds to the recording of the recording flags and recording data in the data recording device 26, for every dataset edited and recorded temporarily in the RAM 23 by the step S200. As shown in FIG. 5, one dataset is constituted by the recording flag and recording data. An area in the data recording unit 26 is constituted so that the recording flag and the recording data are recorded in different areas, when the data set is recorded in the data recording device 26. The recording flag has always a given quantity for each of the datasets. However, the recorded data does not have a given quantity since it is determined by whether the recording is carried out dependent on a variation of the recording data for each of the datasets, but the quantity of recoding data for one dataset becomes equal to the number of pieces of the corresponding dataset, the recording flags of which are set to “1”. Because of this, the recording data is constituted so that the data is recorded from an address at the end of data in one previous dataset, when recording data in a next dataset is recorded. According to such constitution of the data, data can be recorded without creating wasted empty areas.

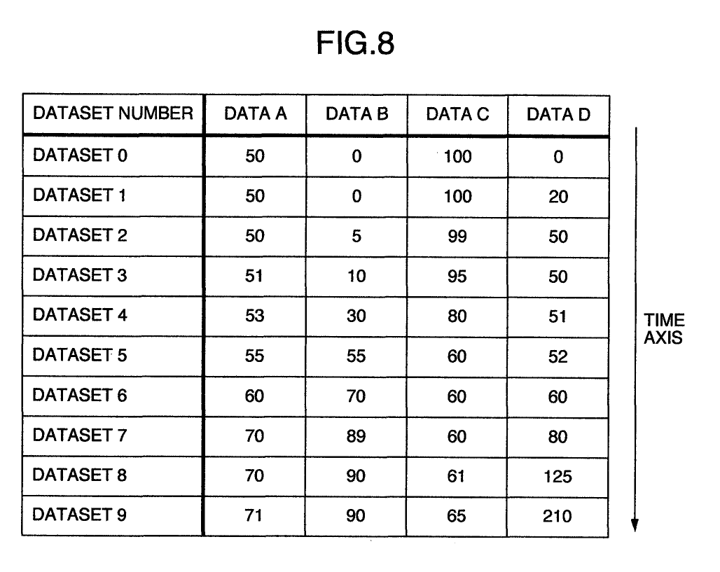

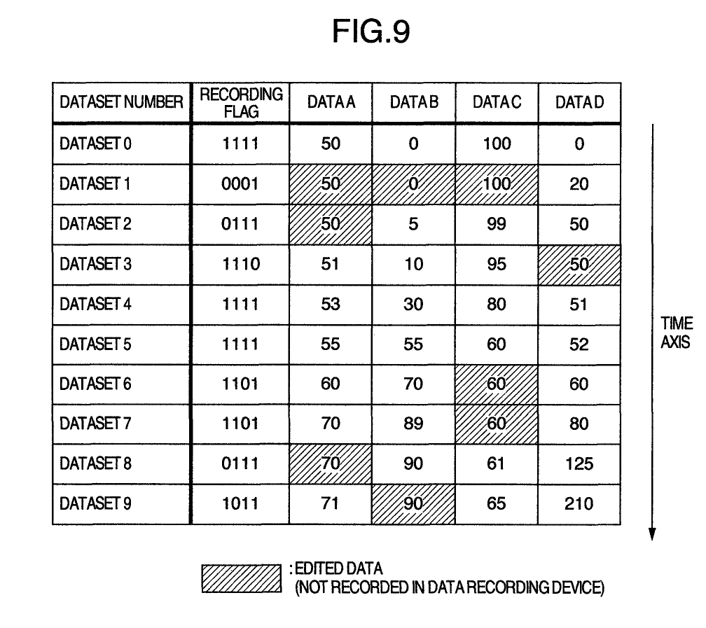

Next, a specific example will be described with the flow charts in FIGS. 2 and 3, the data recorded temporarily in the RAM 23 in FIG. 8, and on the basis of recording flag states for every abnormal occurrence in FIGS. 9, 10 and 11. In this case, there are abnormal occurrences 1 to 3 as shown in FIG. 7, in which data threshold values, number of recording datasets and recording periods are adapted to set to each of the abnormal occurrences 1 to 3, and data to be acquired are four numbers of data A, B, C and D. The abnormal occurrence 1 is adapted to provide that the threshold value of the data A, B, C and D is set to “0”, the number of recording datasets is set to “10”, and the recording period as number of datasets is provided that the number of pieces at the before-abnormal occurrence detection is set to “10” and the number of pieces at the after-abnormal occurrence detection is set to “0”. Likewise, the abnormal occurrence 2 is adapted to provide that the threshold value of the data A, B, C and D is set to “5”, the number of recording datasets is set to “10”, and the recording period is provided that the number of pieces at the before-abnormal occurrence detection is set to “5” and the number of pieces at the after-abnormal occurrence detection is set to “5”. The abnormal occurrence 3 is adapted to provide that the threshold value of the data A, B, C and D is set to “10”, the number of recording datasets is set to “10”, and the recording period is provided that the number of pieces at the before-abnormal occurrence detection is set to “0” and the number of pieces at after-abnormal occurrence detection is set to “10”.

(Case 1) When the abnormal occurrence 1 is detected for the first time since a state indicates that none of the abnormal occurrences are detected, the process carries out the steps S100, S110 and S120, and then moves to S140 because the abnormal occurrence detection is the first time in the step S130. In the step S140, data threshold values corresponding to the abnormal occurrence 1, that is, the threshold value of the data A, B, C and D is set to “0”. Next, the number of recording datasets corresponding to the abnormal occurrence 1 is set to 10 in the step S150. The data recording period corresponding to the abnormal occurrence 1 is set to 10 at the before-abnormal occurrence detection and 0 at the after-abnormal occurrence detection in the step S160. In the step S170, the process judges whether data is acquired within the designated period, however, it is not necessary to acquire data after detecting the abnormal occurrence because the data recording period set by the step S160 is provided that the number of pieces at the before-abnormal occurrence detection is 10 and the number of pieces at the after-abnormal occurrence detection is 0. The process therefore moves to the step S200.

In the step S200, “1” is set to the recording flags for all data of the earliest dataset to be recorded by the step S205, that is, the value of recording flag for the dataset 0 becomes “1111”. Thereafter, the dataset number is increment by 1 in the step S210. In the subsequent step S215, “0” is acquired by calculating a difference between a dataset number 1 and the data A of dataset number 0 (50−50=0). In the step S220, the difference “0” is compared with a threshold value “0” which is set to the data A, and a result of “difference for the data A> the threshold value for the data A” is dissatisfied as a comparison. The process then moves to the step S230, and “0” is set to the recording flag of data A. In the step S235, the value of data A in the dataset 1 is replaced with the value of data A in the dataset 0. This process is repeated by the number of pieces of data included in the dataset, that is, repeated by four times to edit the recording flag and data in the dataset 1 in this case. After the above-mentioned process, the recording flag in the dataset 1 becomes “0001”. The values of data A, B, C and D become “50”, “0”, “100” and “20” transferred from “50”, “0”, “100” and “20”, respectively. After that, the dataset number is increment by “1”, and the process returns to the step S215. This process is repeated by “dataset number-1” times to set the recording flags and edit the data for all datasets. As a result, the values become shown in FIG. 9. The data indicated by hatching represents data applied by the editing, and these pieces of data are not recorded in the data recording device 26. In the abnormal occurrence 1, the threshold value of data A, B, C and D is set to “0”, therefore, the data after the editing becomes data value equal to that recorded temporarily in the RAM 23 in FIG. 8. Incidentally, the total number of recording data becomes 31 because the data indicated by the recording flag set by “1” becomes data to be recorded in the data recording device 26.

(Case 2) Next, description will be concerned with a case where the abnormal occurrence 2 is detected for the first time since a state indicates that none of the abnormal occurrences are detected. The data recorded temporarily in the RAM 23 is the same values as that used in (Case 1) shown in FIG. 8. First, the process carries out the steps S100, S110 and S120, and then moves to S140 because the abnormal occurrence detection is the first time in the step S130. In the step S140, data threshold value corresponding to the abnormal occurrence 2, that is, the threshold value of the data A, B, C and D is set to “5”. Next, the number of recorded datasets corresponding to the abnormal occurrence 2 is set to “10” in the step S150. The data recording period corresponding to the abnormal occurrence 2 is set to 5 at the before-abnormal occurrence detection and 5 at the after-abnormal occurrence detection in the step S160. In the step S170, the process judges whether the data is acquired within the designated period, however, the data recording period set by the step S160 is provided that the number at the before-abnormal occurrence detection is 5 and the number at the after-abnormal occurrence detection is 5. Because of this, the data has not been acquired within the designated period (data acquired for five times after detecting the abnormal occurrence). The process does not move to the step S200, but it is completed. At the next timing, the process carries out the steps S100, S110 and S120 by executing the program. In the step S130, the abnormal occurrence 2 has already been detected, therefore, the process moves to the step S170. The process then completes because data has not been acquired within the designated period. In this way, the program is repeatedly executed until the data is acquired within the designated period, acquiring the data at the after-abnormal occurrence detection.

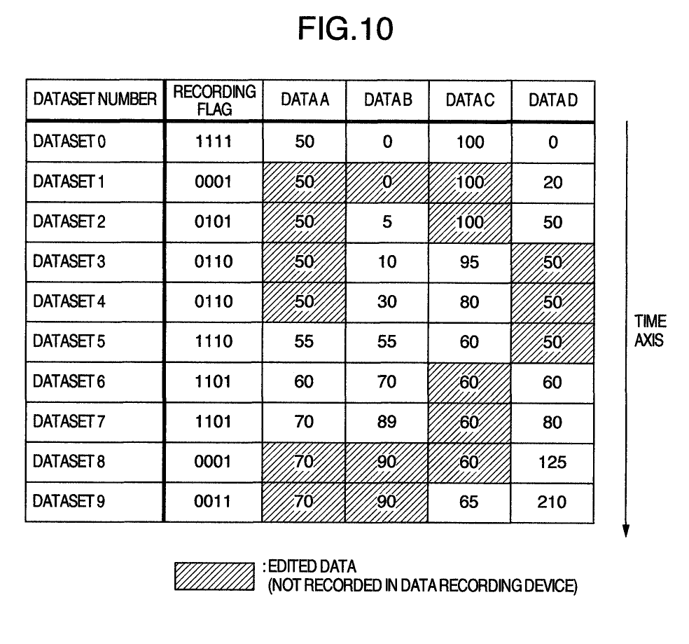

The process then moves to the step S200 after acquiring the data within the designated period. In the step S200, first, “1” is set to the recording flags for all data of the earliest dataset (dataset 0) to be recorded by the step S205. Thereafter, the dataset number is increment by 1 in the step S210. The subsequent steps S215 to S250 are executed similar to those of the (Case 1). Here, the threshold value for every data set by the abnormal occurrence 2 is “5” for each of the data A, B, C and D. Therefore, when the process is completed for the setting of recording flag and the editing of data in the dataset 1, the recording flag of the dataset 1 becomes “0001”, and the data A, B, C and D become “50”, “0”, “100” and “20” transferred from “50”, “0”, “100”, and “20”. Subsequently, when the above-mentioned same process is applied to the dataset 2, the recording flag of data set 2 becomes “0101”, and the data A, B, C and D become “50”, “5”, “100” and “50” transferred from “50”, “5”, “99” and “50”, respectively. Likewise, the above-mentioned process is repeated by “data set number-1” times to set the recording flags and edit the data for all data sets. As a result, the values become shown in FIG. 10. The data indicated by hatching represents data applied by the editing, and these pieces of data are not recorded in the data recording device 26. In the abnormal occurrence 2, the threshold value of data A, B, C and D is set to “5”, therefore, the data after the editing becomes data value partly different from the data recorded temporarily in the RAM 23 in FIG. 8 (for example, the data C in the dataset 2 etc.). Incidentally, the total number of pieces of recording data becomes 23 because the data indicated by the recording flag set to “1” becomes data to be recorded in the data recording device 26.

(Case 3) Next, description will be concerned with a case where the abnormal occurrence 3 is detected for the first time since a state indicates that none of the abnormal occurrences are detected. The data recorded temporarily in the RAM 23 is the same values as that used in the (Case 1) and (Case 2) shown in FIG. 8. First, the process carries out the steps S100, S110 and S120, and then moves to S140 because the abnormal occurrence detection is the first time in the step S130. In the step S140, data threshold values corresponding to the abnormal occurrence 3, that is, the threshold value of the data A, B, C and D is set to “10”. Next, the number of recording datasets corresponding to the abnormal occurrence 3 is set to “10” in the step S150. The data recording period corresponding to the abnormal occurrence 3 is set to 0 at the before-abnormal occurrence detection and 10 at the after-abnormal occurrence detection in the step S160. In the step S170, the process judges whether data is acquired within the designated period, however, the data recording period set by the step S160 is provided that the number of pieces at the before-abnormal occurrence detection is 0 and the number of pieces at the after-abnormal occurrence detection is 10. Because of this, the data has not been acquired within the designated period (data acquired for 10 times after detecting the abnormal occurrence). The process does not move to the step S200, but it is completed. At the next timing, the process carries out the steps S100, S110 and S120 by executing the program. In the step S130, the abnormal occurrence 3 has already been detected, therefore, the process moves to the step S170. The process then completes because data is not acquired within the designated period. In this way, the program is repeatedly executed until the data is acquired within the designated period, acquiring the data at the after-abnormal occurrence detection.

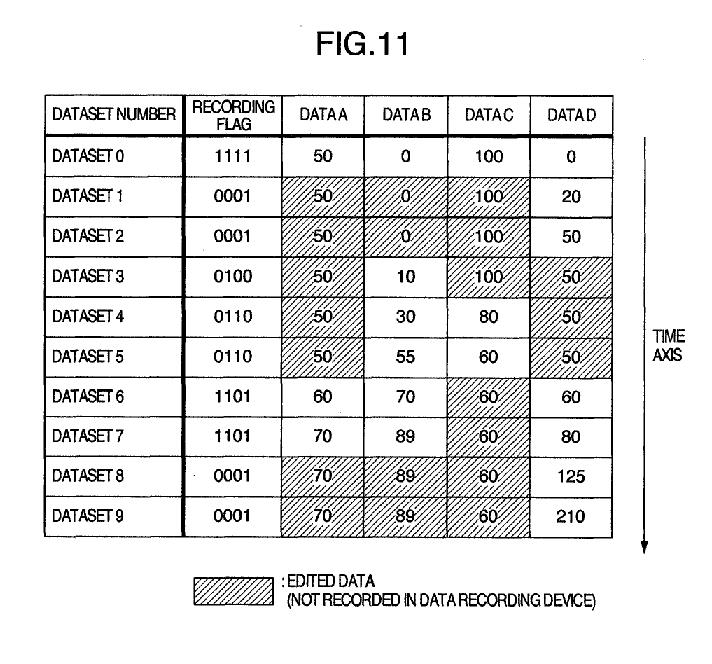

The process then moves to the step S200 after acquiring the data within the designated period. In the step S200, first, “1” is set to the recording flags for all data of the earliest dataset (data set 0) to be recorded by the step S205. Thereafter, the dataset number is increment by 1 in the step S210. The subsequent steps S215 to S250 are then executed similar to those in the (Case 1) and (Case 2). Here, the threshold value for every data set by the abnormal occurrence 3 is “10” for the data A, B, C and D. Therefore, when the process is completed for the setting of recording flag and the editing of data in the dataset 1, the recording flag of the dataset 1 becomes “0001”, and the data A, B, C and D become “50”, “0”, “100” and “20” transferred from “50”, “0”, “100” and “20”. Subsequently, when the above-mentioned process is applied to the dataset 2, the recording flag of dataset 2 becomes “0101”, and the data A, B, C and D become “50”, “0”, “100” and “50” transferred from “50”, “5”, “99” and “50”, respectively. Likewise, the above-mentioned process is repeated by “data set number-1” times to set the recording flags and edit the data for all datasets. As a result, the values become shown in FIG. 11. The data indicated by hatching represents data applied by the editing, and these pieces of data are not recorded in the data recording device 26. In the abnormal occurrence 3, the threshold values of data A, B, C and D are set to “10”, therefore, the data after the editing becomes data value partly different from the data recorded temporarily in the RAM 23 in FIG. 8 (for example, the data C in the dataset 2 etc.). Incidentally, the total number of pieces of recording data becomes 19 because the data indicated by the recording flag set to “1” becomes data to be recorded in the data recording device 26.

Next, the process moves to the step S300 after processed by the step S200 for the (Case 1), (Case 2) and (Case 3), and the dataset including the recording flag is recorded in the data recording device 26 so that an area in the device is divided into a recording flag area and a dataset area. By dividing the recording area into the respective areas, the recording flag and recording data can be recorded in the data recording device 26 without wasteful recording area, even though the total number of pieces of data is different for each of the aggregate of datasets with respect to one abnormal occurrence (the embodiment corresponds to the aggregate of the recording flags and recording data for the datasets 0 to 9), referring to FIG. 6 representing a relationship between the recording flag and recording data.

Here, the constitutional elements in the embodiment are made apparent how they correspond to the element in the claims. The data recording device 26 corresponds to a data recording device, the CPU 21 corresponds to a comparison unit, a judgment unit, a data editing unit, and a recording unit.

According to the data recorder for vehicle in the detailed embodiment as described above, the process can determine arbitrarily whether the data of a time period at which it starts and ends is recorded in the data recording device 26, when data of arising at the before-abnormal occurrence and after-abnormal occurrence is recorded, so that the cause of arising the abnormal occurrence can be ascertained effectively. Further, the process can be determined by whether the recording is carried out by comparing the variation of data acquired for every abnormal occurrence with the arbitrarily set threshold value, so that the accuracy of data to be acquired for every abnormal occurrence can be determined arbitrarily. In addition, the recording capacity is not used wastefully for data having less variation.

Further, the recording flag and recording data are recorded respectively in the different areas on the data recording device 26, therefore, the data can be recorded without creating an empty recording area even in the case that the number of recording data is different.

Incidentally, the present invention is not limited to the foregoing embodiment, and various changes and modifications can be implemented within the technical scope.

For example, the above-mentioned embodiment has described the case of recording the data detected by various types of devices mounted on a vehicle, but the invention may be applied to recording data of various types of devices mounted on a control unit (electronic control device) of a motorcycle, train, airplane, ship, home electric appliance, precision apparatus, etc.

Further, in the above-mentioned embodiment, a given threshold value is set to all the data in one abnormal occurrence as shown in FIG. 7. However, a different threshold value can be given to each piece of the data even in one abnormal occurrence. The threshold value may be set on the basis of characteristic of data to be acquired.

The various types of signals enter through the control unit 10 in the above-mentioned embodiment, however, they may enter directly into the data recorder 20 from the various types of sensors. More specifically, the function of data recorder 20 may be included in the control unit.

Incidentally, a difference between the previously acquired data and the presently acquired data from a data acquiring unit is compared with a threshold value set to each piece of data, the process may thereby judge whether the presently acquired data is recorded. For example, the threshold value is provided largely for data having a large amount of noise such as a pulley rotational speed, a quantity of data is thereby prevented from increasing data by data variation caused by the noise. The threshold value is made small for data indicating that the variation is slow in such a case of the oil temperature in a transmission, or the threshold value is set to 0, thereby, highly accurate data can be recorded.

Further, the threshold value is provided for each piece of the data for comparing it with the difference between the previously acquired data and the presently acquired data from the data acquiring unit. This threshold value may be provided so that the setting can be carried out in correspondence with the abnormal occurrence. For example, the threshold value is made small for specific data of a certain abnormal occurrence, so that data can be acquired with fine accuracy. The threshold value is made large for data which is not specific for a certain abnormal occurrence, so that data can be acquired with coarse accuracy. In this constitution of the threshold value, data can be recorded with necessary accuracy for ascertaining the cause without using the recording areas wastefully.

The data acquired by the data acquiring unit may be constituted to include so that it can recognize the data recorder for vehicle without regard to a sensor value, an instruction value, and an inside and outside of vehicle. In such constitution of the data, the instruction value in the control unit and the actual output value are recorded and they are compared therewith, so that the cause of abnormal occurrence is easily ascertained later.

Further, the recording device 26 used in the data recorder 20 may be of any storage medium accessible from a microcomputer, for example, may be of nonvolatile memory such as EEPROM and Flash ROM, and also FD (floppy disk), CD (compact disk), DVD, hard disk, etc.

The dataset may be provided at every sampling cycle of the data acquiring unit. For example, a slow data group having less variation is made a set together with a fast data group having greater variation. This carries out the data recording program for a vehicle by a different sampling cycle in the invention, so that a sampling cycle can be provided suitably for every data.

Further, the data may be recorded in the data recording device 26 so that the data recorder 20 judges the maximum quantity of data which accepts a previously set data quantity. In such data constitution, a time-series data having a longer time can be recorded without using the previously set data quantity wastefully, so that the cause of an abnormal occurrence can easily be ascertained later.

The data may be recorded in the data recording device 26 so that the data recorder 20 judges a data quantity within a predetermined set time period. In such data constitution, more data quantity than that within a certain time period does not use the storage capacity wastefully, so that the remaining storage capacity can be used for a next arisen abnormal occurrence.

Further, the data recorder 20 may determine so that the recording flag and recorded data for the created data can be arranged on different areas therein, respectively. In such data constitution, the data can be recorded without creating wasteful empty areas when recording data having a variable length, a restricted storage capacity can be used effectively.

The recording data in the data recorder 20 which determines not to be recorded is compensated by the data acquired at one previous cycle, so that data can be restored. Because of this, data can be acquired as if the data is acquired in a sampling cycle provided for every data when the data recorded in the data recorder 20 is analyzed in checking an abnormal occurrence.

Further, the abnormal occurrence may be an abnormal occurrence caused by in-vehicle devices. The invention is applicable primarily for a case of recording data associated with an abnormal occurrence of any devices. Data to be recorded is not limited to the data associated with the abnormal occurrence, but applicable for all devices which record time-series data, particularly for recording data associated with an abnormal occurrence of devices mounted on an automobile, motorcycle, train, ship, airplane, etc.

In the above-mentioned data recorder for vehicle, data acquiring unit at least therein is pointed as program for functioning the computer. This unit may also be program for executing each step by the computer in a data recording method for vehicle. According to this program executed by the computer, advantages of the invention can be obtained by the data recorder for vehicle. Further, the program may be recorded in a computer readable storage medium (for example, ROM, hard disk, FD (floppy disk), CD (compact disk), DVD, etc. The Program may also be distributed through a transmission medium (Internet, LAN, CAN, etc., without regard to wire or wireless), and through any other media for reception and transmission.

It should be further understood by those skilled in the art that although the foregoing description has been made on embodiments of the invention, the invention is not limited thereto and various changes and modifications may be made without departing from the spirit of the invention and the scope of the appended claims.

1. A data recorder, comprising:
a data acquiring unit that acquires data for use in a vehicle;
a comparison unit that compares previously acquired data with presently acquired data;
a judgment unit that judges whether the presently acquired data is recorded in response to a comparison result from the comparison unit;
a dataset management unit that creates a present dataset including present data and a recording flag for the present data when the judgment unit judges that the present data is recorded, and records at least a recording flag of the presently acquired data and does not record the presently acquired data when the judgment unit judges that the presently acquired data is not recorded; and
a recording unit that records the present dataset created by the data set management unit in a recording device.

2. The data recorder according to claim 1, wherein the comparison unit compares a threshold value set to every data with a difference between the previously acquired data and the presently acquired data, acquired by the data acquiring unit, and judges whether the presently acquired data is recorded.

3. The data recorder according to claim 1, wherein the comparison unit sets the threshold value to every data in response to an abnormal occurrence.

4. The data recorder according to claim 1, wherein the data acquired by the data acquiring unit (10) includes a sensor value and an instruction value.

5. The data recorder according to claim 1, wherein the recording device used by the recording unit includes a nonvolatile memory or a hard disk.

6. The data recorder according to claim 1, the dataset is provided at every sampling cycle of the data acquiring unit.

7. The data recorder according to claim 1, the recording unit determines a maximum quantity conformed to a predetermined setting data quantity to record the dataset in the recording device.

8. The data recorder according to claim 1, wherein the recording unit determines a data quantity to be recorded in response to an arisen abnormal occurrence to record the dataset in the recording device.

9. The data recorder according to claim 1, wherein data that is judged not to be recorded is compensated by data acquired at a previous time to carry out to restore the data, with respect to the dataset recorded by the recording unit.

10. The data recorder according to claim 1, wherein the recording flag and recording data are recorded in difference areas of the recording device, respectively, when the dataset is recorded by the recording unit, so that a wasteful empty area is not created in a data recording area even if a recording data quantity is changed.
